(19) United States
(12) Patent Application Publication
(10) Pub. No.: US 2024/0075906 A1
(43) Pub. Date: Mar. 7, 2024

(54) ONE COMPONENT, UV-CURED PUTTY MATERIAL FOR REPAIRING SMALL SURFACE IMPERFECTIONS

(71) Applicant: Illinois Tool Works Inc., Glenview, IL (US)

(72) Inventors: Mehdi Habibpour, Glenview, IL (US); Rick Turpin, Glenview, IL (US); Carlton Seaboldt, Glenview, IL (US); Grant Shouldice, Glenview, IL (US)

(73) Assignee: Illinois Tool Works Inc., Glenview, IL (US)

(21) Appl. No.: 18/237,986

(22) Filed: Aug. 25, 2023

Related U.S. Application Data
(60) Provisional application No. 63/402,960, filed on Sep. 1, 2022.

(51) Int. Cl. B60S 5/00; B29C 73/02; C09D 5/34; C09D 7/61; C09D 167/00; C09D 175/16

(52) U.S. Cl. CPC B60S 5/00; B29C 73/02; C09D 5/34; C09D 7/61; C09D 167/00; C09D 175/16; B29C 2035/0827

(57) ABSTRACT

A method for repairing small surface imperfections on a vehicle body is provided that includes the application of an uncured layer to a thickness of up to 1.02 mm of a composition inclusive of a polyester resin, an acrylated urethane resin, a defoamer, and a particulate filler to the vehicle body or a cured putty thereon. The uncured layer is then exposed to actinic radiation to induce cure of the uncured layer to form a coating to fill the small surface imperfection on the vehicle body. A one component, UV-cured putty material for repairing small surface imperfections is also provides inclusive of a polyester resin, an acrylated urethane oligomer or polymer, a defoamer, a photoinitiator, and a particulate filler. The composition has an uncured viscosity of between 9,000 and 13,000 centiPoise.

### RELATED APPLICATIONS

This application is a non-provisional application that claims priority benefit of U.S. Provisional Application Ser. No. 63/402,960 filed 1 Sep. 2022; the contents of which are hereby incorporated by reference.

### FIELD OF THE INVENTION

The present invention in general relates to unsaturated curable composition for vehicle body repair that cures with ultraviolet (UV) light, and in particular to curable composition used in repairing small surface imperfections on surfaces of auto-body repair coatings.

### BACKGROUND OF THE INVENTION

Body filler compositions are used in the vehicle repair aftermarket industry to repair of deformities such as holes and dents in vehicle bodies. The filler composition cures following application to the deformity and upon reaching a level of hardness, the resulting coating overlying the defect is sanded and finished with suitable painting steps to affect the repair of the vehicle body.

When a thick layer filler material is applied to the damaged area such as dents, defected areas, and holes on automotive body parts, it is cured and then shaped by sanding. During the sanding, pockets of air trapped during application of the coating layer are exposed, which leave a surface with small imperfections such as pinholes. Microspheres within the composition can also be broken during sanding creating a separate basis pin holes in the surface.

These small imperfections are conventionally covered and filled with a subsequent thin layer of polymer composite material called pinhole eliminator to fill the imperfections so subsequently applied layer such as paint layers that are needed to achieve the class A, high sheen surface finish common to exterior, new vehicle surfaces. The ability to control viscosity and cure to avoid pinhole formation would eliminate several remedial steps.

These small imperfections, such as dents or scratches, as the target repair or created through sanding of a conventional filled putty are surprisingly difficult to correct. The viscosity of a composition to flow into and wet such imperfections is problematic and once filled, the need for sanding renders the repair vulnerable to further damage.

Conventional surface repair compositions are often two-part systems that cure under free radical conditions. Mixing errors and ambiguity as to when a repair has reached a sufficient hardness to allow for sanding are common reasons why these remedial repairs must be repeated. The limited working time for a composition once mixing and cure have begun can also lead to rushed efforts to affect a repair. Furthermore, it is commonly believed in the art that pinholes are associated with solvent degassing as a composition cures, the high solvent loadings at the expense of inert filler particulate content associated with these conventional surface repair compositions is a reason pin hole repair is needed.

Thus, there exists a need for improved compositions that address the limitations of the prior art through resort to a one part, UV curable composition that inhibits pinhole formation and is able to wet and fill small imperfections. There further exists a need for a method of using such a composition that is UV curable and provides extensive working time so as to limit the amount of post-cure sanding and then rapidly achieve hardness sufficient to sand, if needed.

### SUMMARY OF THE INVENTION

A method for repairing small surface imperfections on a vehicle body is provided that includes the application of an uncured layer to a thickness of up to 1.02 mm of a composition inclusive of a polyester resin, an acrylated urethane resin, a defoamer, and a particulate filler to the vehicle body or a cured putty thereon. The uncured layer is then exposed to actinic radiation to induce cure of the uncured layer to form a coating to fill the small surface imperfection on the vehicle body.

A one component, UV-cured putty material for repairing small surface imperfections is also provided inclusive of a polyester resin, an acrylated urethane oligomer or polymer, a defoamer, a photoinitiator, and a particulate filler. The composition has an uncured viscosity of between 9,000 and 13,000 centiPoise.

### DETAILED DESCRIPTION OF THE PREFERRED EMBODIMENTS

The present invention has utility as an ultraviolet (UV) light curable composition that is well suited for curing to form a coating directly on a vehicle exterior or a coated vehicle exterior and to fill small surface imperfections. The resulting coating being amenable to overcoating with substances functioning as topcoats, primers, or paints. The present invention affords a user advantages in terms eliminating the need for pinhole revision after common to conventional coating compositions. The rheology of the uncured composition is such that the composition easily flows to afford a smooth layer on a target surface resulting in a uniform layer with limited to no air bubble trapped therein that are discernible to a normal, unaided human eye. Upon cure a coating results that has limited, to no pinholes therein. As a result, the need for curative steps to address pinholes is largely, if not completely obviated.

The uncured inventive composition contains up to 40 total volume percent fillers thereby improving flow and sanding characteristics upon cure. Through resort to a one-part, UV curable composition mixing errors and unlimited working time are provided with a rapid cure once UV cure is initiated. An inventive composition achieves thicknesses of up to (40 mils) 1.02 millimeter (mm). In other embodiments in which a color change agent is present, a user has a visual cue as to when the composition has achieved sufficient hardness to sand so as eliminate yet another deficiency of prior art systems.

As used herein, “small surface imperfection” is defined as having a maximal linear extent in one direction parallel to the surface of from 0.005 to 76 mm. The term being intended to encompass scratches that are longer than these dimensions in a second orthogonal direction relative to those provided. It is appreciated that with filler and putties materials, not only the scratch or dent is filled, but the material is also often applied to edges of the scratch to create a smooth transition that is synonymously referred to as a featheredge. The featheredge region is not considered herein with respect to the dimensions of a defect. It is further appreciated that the repair area is usually circular.

As used herein, “sandable” with reference of a cured inventive composition is defined as having limited clogging of sandpaper and able to form a featheredge.

Embodiments of the inventive compositions provide UV curing coatings utilizing photo polymerization reactions using a variety of light sources such as low energy consuming and environmentally-friendly ultraviolet light emitting diode (UV-LED), older mercury or xenon arc lights, or simply sunlight. Absent UV exposure, an inventive composition has a working time that is longer than conventional two-part, peroxide cured coating system and is effectively infinite, yet cures more rapidly upon UV exposure thereby offering a user a controlled working time and a rapid cure thereafter. As a result, the applied material can be corrected or reworked without the conventional problem of viscosity build. Also, the UV cure of the inventive composition reduces temperature dependency of cure rates compared to conventional surface defect repair systems.

Numerical ranges cited herein are intended to recite not only the end values of such ranges but the individual values encompassed within the range and varying in single units of the last significant figure. By way of example, a range of from 0.1 to 1.0 in arbitrary units according to the present invention also encompasses 0.2, 0.3, 0.4, 0.5, 0.6, 0.7, 0.8, and 0.9; each independently as lower and upper bounding values for the range.

Table 1 lists the major components of an embodiment of the inventive curable composition.

TABLE 1
Composition of a UV curable vehicle body repair composition

| | Typical Total | Preferred Total |
|---|---|---|
| Ingredient | Weight Percent | Weight Percent |
| Polyester resin | 50-85 | 62-82 |
| Acrylated urethane resin | 1-15 | 2-8 |
| Defoamer | 0.1-6 | 0.4-5.2 |
| Photoinitiator | 0.1-5 | 0.1-1.8 |
| Anti-oxidant | 0-6 | 0.1-1.0 |
| Solvent | 0-20 | 0-10 |
| Color changing dye | 0-1 | 0.1-0.7 |
| relating to cure | | |
| Additives | 0-12 | Each: 0.1-12 |
| Filler (e.g. pigment, | Remainder | Remainder (up to 40 |
| talc, microspheres) | | volume percent) |

An inventive polyester resin has a degree of ethylenic unsaturation that is between 20 and 100% of the non-alcoholic monomer in the polyester resin and denotes reactivity within the polyester resin backbone to free radical polymerization. The unsaturation in a polyester backbone is reactive with vinyl and allyl moieties of a styrenic or non-styrenic molecule through free-radical polymerization.

In some embodiments, an inventive unsaturated polyester resin is terminally functionalized with molecules illustratively including allyl glycidyl ether, glycidyl methacrylate, trimethylolpropane diallyl ether, allyl pentaerythritol or polymeric allyl glycidyl ether.

An inventive unsaturated polyester is readily formed in a single reaction or in multi-stage reactions. Typical reaction temperatures range from 130-240° C. A conventional esterification catalyst is present and illustratively includes acids, transition metal catalysts and organo-tin compounds. Typical catalyst loadings range from 0.01 to 1 total weight percent of the reactants.

Reactive polyester resins used in a composition for repairing imperfections on surfaces of auto-body repair coatings have a weight average molecular average weight ranging from 5,000 to 600,000, as determined by gas permeation chromatography (GPC). For purposes of calculating monomer percent, reactive diluents are omitted. Based polyester resin compositions operative herein are detailed in Table 1. Typical loadings of polyester resin in an inventive composition are from 50 to 85 total weight percent of a fully formulated composition.

According to some inventive embodiments, a suitable defoamer is typically provided to inhibit frothing of the formulation and the resulting pinholes. Defoamers operative herein illustratively include trade designations “BYK-1794”, “BYK-1790”, and “BYK-A 550 (BYK Additives & Instruments, Wesel, Germany); silicone compounds, such as, dimethyl silicone oil, alkyl-modified silicone oil and fluoro-silicone oil; and organic siloxane surfactants. A defoamer is typically present from 0.1 to 6 total weight percent.

An actinic radiation curable resin is also present in some embodiments of an inventive composition in the form of an acrylated urethane oligomer or polymeric resin. Such resins are readily formed from polyether polyol, a diisocyanate and hydroxyethyl acrylate. The resin typically has a number average molecular weight of 1,000 to 20,000 Daltons as measure by GPC. Diisocyanates operative herein illustratively include dicyclohexyl methane diisocyanate, isophorone diisocyanate. It is appreciated that aliphatic urethane acrylate resins are typically sold commercially as a 60 to 85% by weight in a diluent such as trimethylolpropane triethoxy triacrylate, pentaerythritol tri/tetraacrylate, or the like. Still other actinic radiation curable resins operative herein are detailed in U.S. Pat. No. 5,908,873. Typical loadings of acrylated urethane in an inventive composition are from 3 to 20 total weight percent of a fully formulated composition.

In order to achieve enhanced rates of actinic cure, a photoinitiator is present from 0.1 to 5 total weight percent. Bisacylphosphine oxides (B APO) are exemplary of a photoinitiator operative in the present invention. Specific bisacylphosphine oxides operative herein illustratively in phenyl bis(2, 4, 6-trimethylbenzoyl)-phosphine oxide, diphenyl(2,4,6-trimethylbenzoyl)phosphine oxide, bis-(2,6-dichlorobenz yl)phenylphosphine oxide, bis-(2,6-dichlorobenzoyl)-2,5-dimethylphenylphosphine oxide, bis-(2,6-dichlorobenzoyl)-4-ethoxyphenylphosphine oxide, bis-(2,6-dichlorobenzoyl)-4-biphenylylphosphine oxide, bis-(2,6-dichlorobenzoyl)-4-propylphenylphosphine oxide, bis-(2,6-dichlorobenzoyl)-2-naphthylphosphine oxide, bis-(2,6-dichlorobenzoyl)-1-napthylphosphine oxide, bis-(2,6-dichlorobenzoyl)-4-chlorophenylphosphine oxide, bis-(2,6-dichlorobenzoyl)-2,4-dimethoxyphenylphosphine oxide, bis-(2,6-dichlorobenzoyl)decylphosphine oxide, bis-(2,6-dichlorobenzoyl)-4-octylphenylphosphine oxide, bis-(2,6-dimethoxybenzoyl)-2,5-dimethylphenylphosphine oxide bis-(2,6-dimethoxybenzoyl)phenylphosphine oxide, bis-(2,4,6-trimethylbenzoyl)-2,5-dimethylphenylphosphine oxide, bis-(2,6-dichloro-3,4,5-trimethoxybenzoyl)-2,5-dimethylphenylphosphine oxide, de, bis-(2,6-dichloro-3,4,5-trimethoxybenzoyl)-4-ethoxyphenylphosphine oxide, bis-(2-methyl-1-naphthoyl)-2,5-dimethylphenylphosphine oxide, bis-(2-methyl-1-naphthoyl)phenylphosphine oxide, ethyl-1-naphthoyl)-4-biphenylphosphine oxide, bis-(2-methyl-1-napthoyl)-4-ethoxyphenylphosphine oxide, bis-(2-methyl-1-naphthoyl)-2-naphthylphosphine oxide, bis-(2-methyl-1-naphthoyl)-4-propylphenylphosphine oxide, bis-(2-methyl-1-naphthoyl)-2,5-dimethylphosphine oxide, bis-(2-methoxy-1-naphthoyl)-4-ethoxyphenylphosphine oxide, bis-(2-methoxy-1-naphthoyl)-4-biphenylphosphine oxide, bis-(2-methoxy-1-naphthoyl)-2-naphthylphosphine oxide, bis-(2-chloro-1-naphtho 1)-2,5-dimethylphenylphosphine oxide, and combinations thereof. Still other photoinitiators operative herein include mono-aryl ketones, and trimethylbenzoyldiphenyl phosphinates, with specific examples thereof illustratively including 1-hydroxycyclohexyl phenyl ketone, 2-hydroxy-2-methyl-1-phenyl-propan-1-one, ethyl-2,4,6-trimethylbenzoylphenyl phosphinate In some inventive embodiments, liquid blends of photoinitiators are provided by dissolving solid bisacylphosphine oxide photoinitiator in another liquid photoinitiator or a photoinitiator blend which is of liquid form.

In some inventive embodiments, an anti-oxidant is present in a UV curable coating composition and without intending to be bound to a particular theory is believed to function as a cure inhibitor to mitigate premature cure. An antioxidant operative herein illustratively includes butylated hydroxyanisole, 2,6-di-ter-butyl cresol, 2,2′-methylene bis(6-t-butyl-4-methyl phenol), 2,2′-thio bis(6-t-butyl-4-methyl phenol), tert-butyl hydroquinone, di-tert-butyl hydroquinone, di-tert-amyl hydroquinone, methyl hydroquinone, p-methoxy phenol, tetrakis[methylene-3-(3′,5′-di-tert-butyl-4′-hydroxyphenyl)propionate]methane, N-(2-aminoethyl)-3-[3,5-bis(tert-butyl)-4-hydroxyphenyl]propanamide, 5,7-di-tert-butyl-3-(3,4,-dimethylphenyl)-3H-benzofuran-2-one, dilauryl thiodipropionate, dimyristyl thiodipropionate, tris(nonylphenyl) phosphite, and combinations thereof. Typical loadings of an antioxidant in an inventive composition are from 0 to 6 total weight percent of a fully formulated composition.

To further control viscosity and while not intending to be bound by theory, it is believed that solvents can be effective as a dispersive vehicle for the fillers and resins in an inventive composition prior to curing, yet without inducing pinholes upon cure; while flow control soluble additives and rheological particulate fillers, such as silica, can be used to increase uncured composition viscosity. In some inventive embodiments, no solvent is present to yield a During the application of the composition, solvents aid in achieving a thinner viscosity of the composition. However, after the coating has been cured, it can be expected that there is less than 0.1% of the solvent to no detectable residual solvent. Solvents operative herein illustratively include hydrocarbons, alcohols, polyols, ketones, ethers, and pyrrolidinones, subject to the proviso that the solvent has a molecular weight of less than 300 Daltons. Examples of hydrocarbons operative herein illustratively include Stoddard solvent, toluene, xylene, naphtha, petroleum distillates, ethyl benzene, trimethyl benzenes, and fractions of hydrocarbon mixtures obtained from petroleum refineries. Alcohols operative herein illustratively include ethanol, n-propanol, iso-propanol, n-butanol, iso-butanol, benzyl alcohol, 2-(n-propoxy)ethanol, 2-(n-butoxy)ethanol, 3-(n-propoxy)ethanol, and 2-phenoxyethanol. Ketones operative herein illustratively include acetone, methyl ethyl ketone, methyl n-propyl ketone, methyl n-butyl ketone, methyl amyl ketone, and methyl isoamyl ketone. Esters operative herein illustratively include ethyl propanoate, ethyl butanoate, ethyl glycolate, propyl glycolate, butyl glycolate, and isoamyl glycolate, methyl acetate, ethyl acetate, n-butyl acetate, isoamyl acetate, and t-butyl acetate. Glycols operative herein illustratively include ethylene glycol and polypropylene glycol. Glycol ethers operative herein illustratively include propylene glycol monomethyl ether and ethylene glycol monobutyl ether. Pyrrolidinones operative herein illustratively include 1-methyl-2-pyrrolidinone and 1-ethylpyrrolidin-2-one. Mixtures of any two or more of these solvents may also be utilized. Mixtures of miscible combinations of any of the aforementioned are also appreciated to be operative herein. Solvent is typically present in an inventive composition from 0 to 20 weight percent.

A color changing dye indicative of the extent of cure is detailed in US2020/0239710A1. Such a color changing dye affords a visual cue as to when the cured composition is amenable to sanding. Color changing dye is typically present in an inventive composition from 0 to 1 weight percent.

Several other additives are readily included in an inventive composition that illustratively include flow control additives, pigments and dyes. and combinations thereof. Generally, each of the aforementioned additives is independently present from 0 to 12 total weight percent.

Filler particulates or fibers operative in the present invention illustratively include silica, talc, alumina trihydrate, calcium sulfate, calcium carbonate, magnesium sulfate, magnesium carbonate, barium sulfate, microspheroids and the like. A filler is present as the remainder total weight percent of a complete composition for application to a substrate, with a typical upper limit being 40 volume percent of the uncured composition. It is appreciated that a pigment and filler can have the same function and in those instances where both are present in a composition, the amounts of both are cumulative. Furthermore, some fillers, such as silica, are appreciated to impart rheological properties to the uncured composition.

As used herein a microspheroid is defined to include a hollow microsphere or a solid bead having an aspect ratio of between two normal maximal linear dimensions of between 1 and 1.6. Typically, a spheroid particle is formed of glass or a thermoplastic material. In some inventive embodiments, the microspheroid is within 10 linear dimension percent of spherical and formed of glass. A microspheroid typically has a longest linear dimension of between 20 and 100 microns to improve sandability and reduce density.

It is appreciated that the composition is readily be reapplied as many times as necessary, either before or after initiation of cure to fill surface imperfections. Each application being by applied by brushing, spraying, wiping, or blade spreading. Typical viscosities of an inventive composition fully formulated range from 9000-13,000 Centipoise (cP), as measured by tube viscosity measurement.

The UV radiation necessary for curing can be provided from several sources, including mercury arc lamps, xenon arc lamps, and UV-light emitting diodes (UV-LED). Because of the lower consumption of energy, and reduced heating of the substrate, UV-LED curing is often a preferred actinic radiation source for curing relative to a mercury arc lamp. The UV-LED bulbs do not generate ozone, in contrast to the typical UV-bulbs, require less energy, and exhibit a longer lifetime. The absence of mercury also promotes ease of disposal. UV LEDs emissions a 365 nm, 385 nm, 395 nm, and 405 nm, are each alone or in combination suitable for inducing cure of an inventive composition. Typical rates of cure for an inventive composition is 0.3 to 2 minutes for 1 mm thick composition.

The present invention is further detailed with respect to the following non limiting examples. These examples are not intended to limit the scope of the invention but rather highlight properties of specific inventive embodiments and the superior performance thereof relative to comparative examples.

### EXAMPLES

### Example 1

An inventive composition is provided based on a polyester resin (73 total weight percent), acrylated urethane resin (5 total weight percent), a silicone-free defoamer (2.6 total weight percent), a TPOL photoinitiator (CAS: 84434-11-7, 1.7 total weight percent), tert-butyl hydroquinone (0.4 total weight percent), and the remainder being equal parts of silica particles, 24 micron talc particulate filler and microspheres. The inventive composition filled a pinhole containing sanded putty to a thickness 1.02 mm on a vehicle exterior. After exposure to actinic radiation from a UV-LED at 395 nm for 300 seconds, the sanded substrate with an inventive cured coating is free of pinholes as measured with an unaided, normal human eye.

### Example 2

The process of Example 1 is repeated with the acrylated urethane resin present at 12 total weight percent instead of 5 total weight percent of Example 1. A similar cure profile results.

### Example 3

The process of Example 1 is repeated with the polyester resin present at 84 total weight percent instead of 73 total weight percent of Example 1. A similar cure profile results.

### Example 4

The process of Example 1 is repeated with color changing Red Dye FR-1 per US2020/0239710A1 present at 0.4 total weight with a like amount reduction in the amount of solvent of Example 1. A similar cure profile results and a color change occurs within 5 minutes of “ready to sand” hardness of the resulting coating.

### Comparative Examples

The process of Example 1 is repeated without acrylated urethane and the amount of the polyester resin increased by a like amount. The resulting layer is tacky at surface and the cure is incomplete.

The process of Example 1 is repeated without TPOL photoinitiator. The coated layer does not cure.

These examples demonstrate the processes to be claimed in this patent filing. It should be remarked that other additions and modifications as known in the art are also expected to be covered.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

1. A method for repairing small surface imperfections on a vehicle body comprising:
applying an uncured layer to a thickness of up to 1.02 mm of a composition comprising: a polyester resin, an acrylated urethane resin, a defoamer, and a particulate filler to the vehicle body or a cured putty thereon; and
exposing the uncured layer to actinic radiation to induce cure of the uncured layer to form a coating to fill the small surface imperfection on the vehicle body.

2. The method of claim 1 further comprising applying an overlayer of a primer or paint on the coating.

3. The method of claim 1 wherein the actinic radiation is emission from an ultraviolet light emitting diode.

4. The method of claim 1 wherein the primer composition has a viscosity of between 9,000 and 13,000 centiPoise at standard temperature and pressure.

5. The method of claim 1 wherein the exposing is from 0 seconds to 300 seconds.

6. The method of claim 1 wherein the coating is formed independent of pinholes.

7. A coating formed by the method of claim 1 devoid of pinholes visible to an unaided, normal human eye with a thickness of up to 1.02 mm.

8. The coating of claim 7 further comprising an overlayer of a primer or paint.

9. A one component, UV-cured putty material for repairing small surface imperfections comprising:
a polyester resin;
an acrylated urethane oligomer or polymer;
a defoamer;
a photoinitiator; and
a particulate filler, and having an uncured viscosity of between 9,000 and 13,000 centiPoise.

10. The primer composition of claim 9 further comprising an aliphatic urethane acrylate resin.

11. The primer composition of claim 9 wherein the defoamer is silicone-free.

12. The primer composition of claim 9 wherein the particulate filler comprises at least one of: silica, talc, alumina trihydrate, calcium sulfate, calcium carbonate, magnesium sulfate, magnesium carbonate, barium sulfate, or microspheroids.

13. The primer composition of claim 9 further comprising a color changing dye indicative of extent of cure.

14. The primer composition of claim 9 further comprising at least one additive of a flow control additive, a pigment, a dye, or a combination of any of the aforementioned.

15. The primer composition of claim 14 wherein each of the at least one additive is independently present up to 12 total weight percent.
